(19) United States
(12) Patent Application Publication
(10) Pub. No.: US 2014/0289086 A1
(43) Pub. Date: Sep. 25, 2014

(54) Electronic Futures Spread Exchange System And Method

(71) Applicant: Thomas P. Anderson, Chicago, IL (US)

(72) Inventor: Thomas P. Anderson, Chicago, IL (US)

(21) Appl. No.: 13/917,230

(22) Filed: Jun. 13, 2013

Related U.S. Application Data
(60) Provisional application No. 61/659,570, filed on Jun. 14, 2012.

(51) Int. Cl. G06Q 40/04

(52) U.S. Cl. CPC G06Q 40/04
USPC 705/37

(57) ABSTRACT

The present invention creates a futures exchange trading futures and futures options spread products. More specifically, the present invention will create a futures exchange that will list a variety of futures and futures options (intra and inter market) spread instruments. These unique spreads will be created from ongoing price discovery generated at global exchanges but then converted into a tradable single currency product at the new exchange. The product will be cash settled and deliverable in the traded currency.

This application claims priority from provisional Patent Application No. 61/658,570 filed on Jun. 14, 2012.

### FIELD OF THE INVENTION

The present invention relates to a system and method for a novel electronic futures spread exchange.

### BACKGROUND OF THE INVENTION

History has proven that start-up futures exchanges which compete head-to-head with incumbent exchanges and their established core products have a propensity to fail. For example, the Eurex U.S. and the Cantor Fitzgerald exchanges were both failures. Prior start-up futures exchanges have initiated hostile business models that directly threatened either The Chicago Mercantile Exchange or the Chicago Board of Trade market share in major financial futures products such as Eurodollars or Treasury Notes. In the end, the exchange with the deepest franchise liquidity always survives.

Futures exchanges, unlike brokerage businesses, have been able to maintain protected profit margins supported not only by customers seeking liquidity and strong product brand, but now also by Federal government regulations such as Dodd-Frank. Barriers to enter the exchange business appear to be insurmountable due to the complexities of government regulation and the position of incumbent exchanges. Eventually, free market initiative and viable product development will likely alter the exchange landscape.

### SUMMARY OF THE INVENTION

The present invention is directed to a novel electronic exchange that: 1) lists global inter and intra market spreads, 2) converts the spread to single currency (i.e. U.S. dollars), 3) publishes the spread in that single currency (i.e. U.S. dollars), 4) trades and settles those spreads in single currency (i.e. U.S. dollars), and 5) has a unique non-fee based transaction model. The exchange model will attract customers of all origin—institutional, retail, market-makers and high-velocity.

The Global Futures Spread Exchange (GFS-X) will be a Designated Contract Market (DCM) regulated by the Commodity Futures Trading Commission, an independent agency of the United States government that regulates futures and options. The GFS-X instruments utilize some of the features of core markets from major exchanges such as the CME, CBOT, NYMEX, COMEX, LIFFE, EUREX, MATIF, ICE, and LME. The GFS-X offers inter and intra exchange single currency denominated cash value spreads and will have a fee structure whereas any market participant can benefit by providing liquidity (make) or for taking liquidity (take). The “make/take” fee structure is a first time U.S. futures industry pricing system, unique to the fee based exchange system prevalent globally today. The GFS-X unique dollar denominated spread instruments offer viable and unique trading diversity that will meet the criteria necessary to attract algorithmic, institutional, hedging and retail demand.

Unlike the driving force behind previous failed exchanges, GFS-X instruments will complement existing exchange traded products and add to the volume and liquidity at incumbent exchanges. The GFS-X pricing data relies on widespread market-making by liquidity providers based on other exchange pricing feeds. The outcome of this quoting structure is the tightest possible bid-offer spreads as underlying markets constantly shift.

In one aspect of the invention, the GFS-X utilizes a clearing house, such as the Chicago Mercantile Exchange Group, OCC, NYSE, DTCC or ICE. The clearing house provides clearing, margining and risk for the GFS-X instruments. The GFS-X instruments will offer less systemic risk to the financial system as such instruments will naturally offer trades at a lower margin than what occurs today and may offset with core exchange products at the clearinghouse level. Risk offset that better leverages the capital of trading participants is paramount to trading activity contributing to exchange growth in today's capital markets. The trading world is in a position to support a new style of exchange that offers unique instruments in U.S. and foreign arbitrage contract constructions.

In another aspect of the invention, the GFS-X will utilize a core listing of spread instruments that are European, Asian and American centric providing overlapping trading times. The listings could include inter-exchange futures spreads on U.S. short and longer term interest rate products such as Treasury Bonds, Treasury Notes, Eurodollars and foreign rate products such as Bunds, Bobl, Schatz, Euribor and Sterling as well as global stock indices replicating S+P 500, NASDAQ 100, German STOXX & DAX and the FTSE 100. Other immediate targets are energy, metals and agricultural products. The key is that the GFS-X converts, publishes, trades and settles all futures products using a single currency, i.e. U.S. dollars.

In the invention, expiration cycles are based upon weekly, bi-monthly or quarterly cycles which mimic the trading and expiration cycles of underlying deliverable core futures products. Options on these instruments will also be constructed.

The primary goal of the GFS-X is to bring to market a global complementary set of trading instruments. GFS-X instruments will enhance the volume of established exchange core products while increasing participation and reducing risk. The intention is to minimize the barriers to exchange access through a new and unique exchange fee structure.

It is yet another object of the present invention to create a futures exchange based on domestic and foreign inter and intra exchange spreads. These instruments will trade the difference between products on multiple exchanges using a singular currency, i.e. U.S. dollar. The instruments will be quoted by trading participants using current exchange contract prices converted into the deliverable currency, i.e. U.S. dollars. Underlying examples by asset class would be interest rates, foreign currency, stock indices, agricultural and energy products.

It is a further object of the present invention to institute a U.S. futures industry first “make/take” transaction model in an open exchange environment where any type of customer would be eligible to participate.

Still yet another object of the present invention is to develop the exchange with another registered DCM or fund development of the exchange through private placement.

A further object of the present invention is to utilize clearinghouse partner(s) that offer full facilities management in the margining, risk, technology and back-office needs of the exchange.

Another object of the present invention is the ongoing marketing and operational aspects of running the first exchange that trades futures spread instruments amongst and between major global futures contracts.

### DESCRIPTION OF THE DRAWINGS

Various other objects, features, advantages and benefits of the present invention will be more fully appreciated from the following detailed description of the preferred embodiment when considered in conjunction with the accompanying drawings:

FIG. 1 is a diagram of the entire Global Futures Spread Exchange system.

FIG. 2 is a further diagram of the entire Global Futures Spread Exchange system.

FIG. 3 is a diagram of the second embodiment of the Global Futures Spread Exchange system.

### DETAILED DESCRIPTION OF THE PREFERRED EMBODIMENT

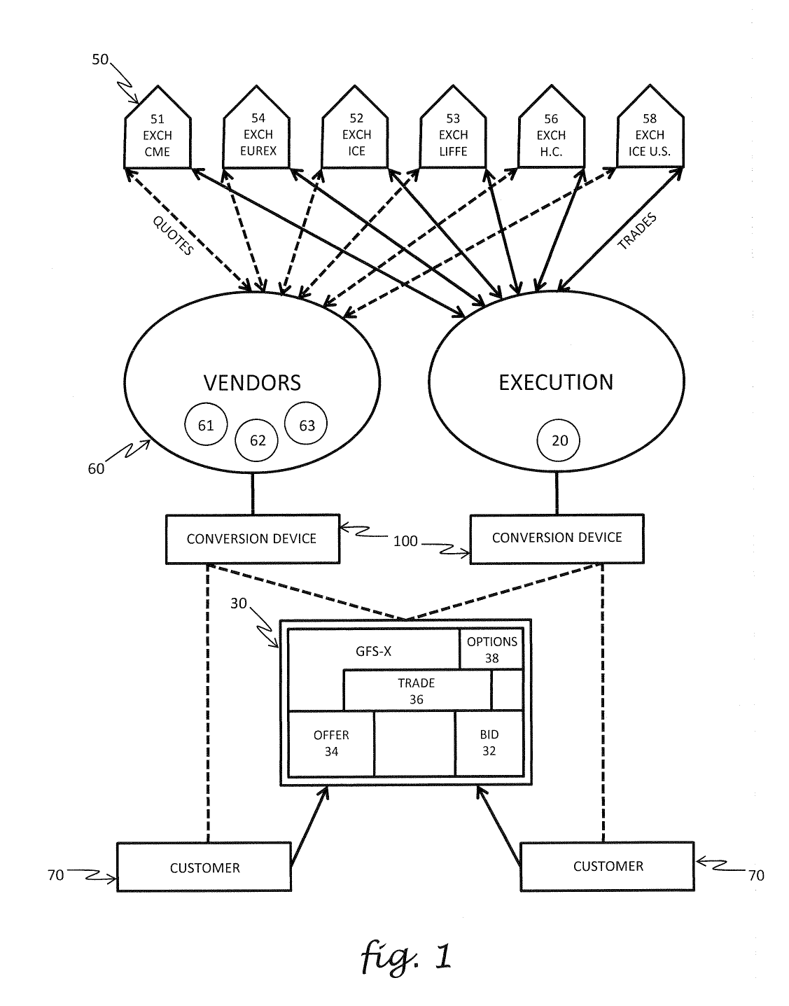

Referring to the drawings, and more particularly to FIG. 1, the GFS-X 30 system includes exchanges 50; vendors 60; customers 70, the GFS-X 30 and conversion devices 100.

The system operates in the following manner.

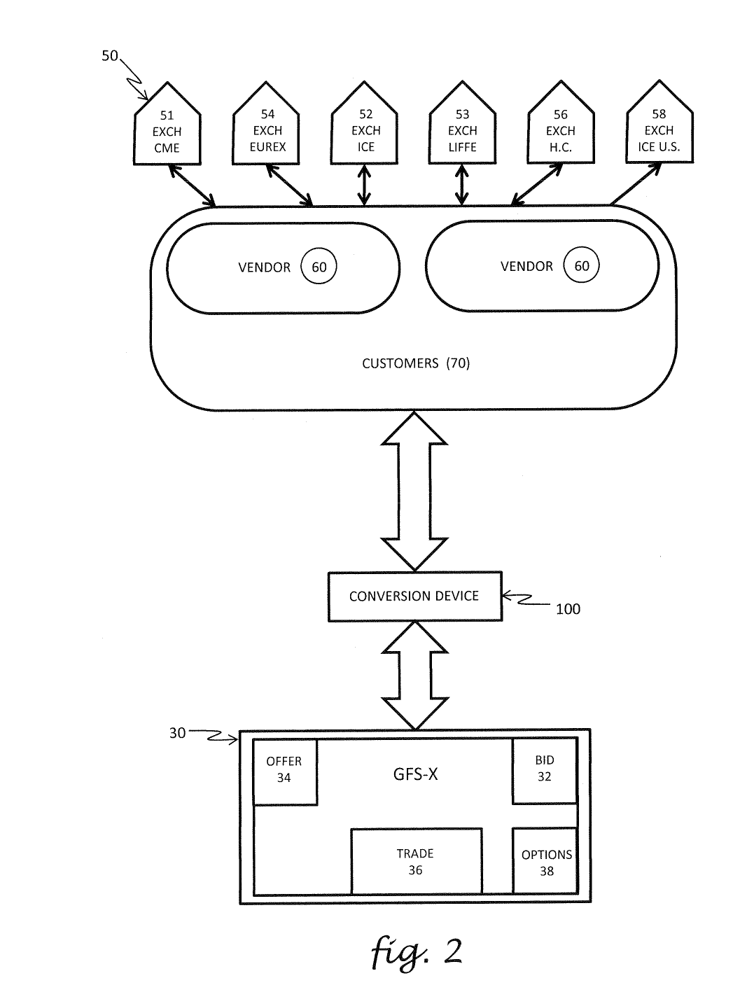

As can be seen in FIGS. 1 and 2, various exchanges 50 such as The Chicago Mercantile Exchange 51; Intercontinental Exchange 52; The New York Stock Exchange Liffe Exchange 53; Eurex ExChange 54; K.C. Exchange 56 and ICE U.S. 58 publicly distribute quotes provided by a market number. The quotes on the exchanges 50 are sent from the exchanges 50 to customers 70 or vendors 60. A vendor 60 is a service used to customers 70 to view quotes from the exchanges 50. Vendors 60 are typically charting tools and re-distributors of quotes. The exchanges 50 charge for quotes is typically passed on to the customers 70. An example of a vendor 60 includes Commodity Quote Graphics (CQG) or Bloomberg Tradebook. Alternatively, an exchange member customer could receive the quote directly from one or more of the various exchanges at very little, if any, cost. Another type of vendor utilized offers exchange execution platforms to customer and member customers alike. These platforms and systems connect directly to the exchanges matching engine. They receive quotes and display “last sale price,” “bids/offers,” “quantity traded,” and “quantities on bids and offers.” A conversion device 100 which may be located at the quote vendor, execution platform or customer level immediately converts the quote sent from the various exchanges 50 to a single denomination, such as, by way of example, the U.S. Dollar. The converted quote is then published to customers 70 who are interested participants in the Global Futures Spread Exchange (GFS-X) 30. The customers 70 may have direct access to the GFS-X 30 or also may have access, through one or more of the vendors 60, and have the ability to either buy or sell at the market (market taker) 32, or alternatively, to set the price by bidding or offering (market maker) 34 for a futures trade 36 in the single currency denominated spread products listed on the GFS-X 30. If an offer to buy (market taker) 32 matches the offer to sell (market maker) 34, a contract or futures trade is executed 36 on the GFS-X using the single currency selected by the GFS-X exchange 30. The executed contract/trade is then sent into a process, such that the executed contract or trade 36 can be reported to a clearinghouse 20. In essence, the GFS-X 30 offers a unique exchange platform for the execution of global spreads in a single currency which provides ease in clearing and margining at the clearing house and futures commission merchant (FCM) level.

Additionally, the GFS-X 30 will list options trading as part of the exchange. Options trading 38 on the GFS-X 30 is based on the underlying futures listed on the GFS-X 30. The GFS-X 30 will create an options series or strike points based upon the underlying futures market places 36. The options portion of the exchange is just a subset of the GFS-X 30 system.

The clearinghouse 20 will be a financial institution that provides clearing and settlement services for financial and commodities derivatives and securities transactions. These transactions may be executed on a futures exchange or securities exchange, as well as off-exchange in the over-the-counter (OTC) market, although the clearinghouse 20 could be a settlement agent for both equities and futures. A clearinghouse 20 stands between two clearing firms (also known as member firms or clearing participants) and its purpose is to reduce the risk of one (or more) clearing firms failing to honor their trade settlement obligations. A clearing house 20 reduces the settlement risks by netting off-setting transactions between multiple counterparties, by requiring collateral deposits (a.k.a. margin deposits), by providing independent valuation of trades and collateral, by monitoring the credit worthiness of the clearing firms, and in many cases, by providing a guarantee fund that can be used to cover losses that exceed a defaulting clearing firm's collateral on deposit.

Generally, the system operates in the following manner: Quotes are publicly distributed on one or more open exchanges 50 which may trade using different currencies. Market makers 70 and 60 use the quotes from the open exchanges to formulate underlying futures pricing and establish the spread price of the two instruments. The quotes from the open exchanges 50 are converted to a single currency 100 by a conversion device 100. This is published not only to customers 70 but also on the GFS-X 30 exchange. The GFS-X 30 exchange establishes the spread quote 38 and displays the spread quote 38 within the GFS-X 30. The GFS-X 30 exchange also displays a bid offer 32 and 34. The spread quote 38, bid 32, offer 34 and trade 36 are conducted in a single currency within the GFS-X 30. Customers on the GFS-X 30 exchange may execute a trade utilizing the last trade spread quote 38 or on the bid 32 or offer 34. The executed trade 36 is then sent to a clearinghouse 20 for settlement. The executed trade 36 may proceed through the conversion device 100 prior to being sent to the clearing house 20.

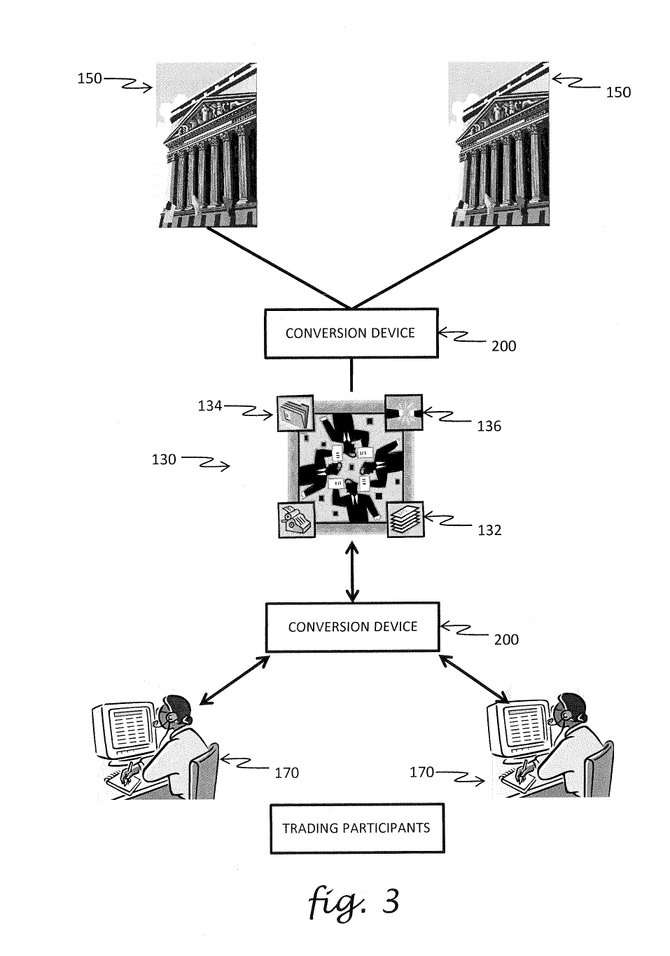

In FIG. 3, the GFS-X 130 is an exchange where trading participants may trade futures contracts; or more particularly spread instruments that are European, Asian or American and that may trade during overlapping time zones. The GFS-X 130 has several components. The GFS-X 130 contains Global Inter-Market Spreads, trades executed on the Global Inter-Market Spreads in a single currency, i.e. the U.S. dollar, and will operate under a liquidity provision transaction model. The global spreads are converted using a conversion device 200 to a single currency, i.e. U.S. dollars, prior to being inputted into the GFS-X 130.

The GFS-X 130 has a trade flow mapping functionality that will provide liquidity coding for the make-take, take-make model of executed instructions. The GFS-X 130 includes: (1) the commodity or futures trades being offered 134; (2) the futures bid 132; (3) the contract negotiated between the buyer and seller of the underlying futures contract 136; and (4) the exchange liquidity charge paid for delivery of the contract. The trading participants 170 can be either individuals or institutions. The trading participants may trade using a computer. The GFS-X 130 operates using a single currency. Therefore, all commodities or orders must be posted and executed on the exchange using the currency value after it has been converted from its original currency into the single currency utilized by the GFS-X 130. The GFS-X 130 utilizes and displays the converted quotes and trades or commodities using a single currency, i.e. U.S. dollars.

The trading participant 170 “makes” a market by posting a bid or offer on the underlying futures contract 136 that he desires to trade on the GFS-X 130. The trading participant 170 that makes the market 134 sets a price and quantity willing to trade. The price 134 has been converted into single currency, i.e., U.S. dollars, by the conversion device 200. The price is converted to a single currency by a conversion device 200 prior to being entered into the GFS-X 130. Additionally, a market participant 170 may be interested in trading options on the GFS-X 130. The participant may publish a bid offer for an option on the GSF-X listed futures products.

Once a buyer 170 who makes the offer 134 and seller 170 who takes the offer 132 are matched within the GSF-X 130, a contract is made 136 and sent to the registered clearinghouse for trade and liquidity settlement whereas the market maker 134 is paid and the market taker 132 is charged for the trade.

GFS-X 130 displays quotes by market makers 134 (any willing trading participant) 170 who will use underlying futures prices traded on incumbent global exchanges and when necessary, spread prices, converted to single currency, i.e. U.S. dollars, and redisplayed as a spread quote with a bid offer and size.

In its simplest form, once a quote leaves any incumbent futures exchange 150 and ends up at a paying customers location 170, through vendors such as CQG, Bloomberg or Trade Station or servers at co-location data centers for algorithmic trade computation, that customer 170 can interact with those paid for quotes any way that customer chooses, except redistribution. Therefore, the customer 170 can react to those prices by transacting back into the market where the quote came from or opt to react in another market. Additionally, that customer 170 can also convert that paid for quote into another product and make a market somewhere else. In effect, GFS-X 130 provides a platform for buyer 132 and seller 134 to meet in an efficient manner to trade bundled futures products not offered currently on any exchange.

Coupled with the unique GFS-X 130, the liquidity provision exchange transaction model as well as all the “optionality” the products will provide it, will become an exchange of choice for all trading participants 170 as futures markets continue to evolve through this decade and beyond.

A brief discussion of the exchange pricing model may prove helpful. Looking at FIGS. 1 and 2, the first is a Make-Take model. In a Make-Take model, the provider of liquidity 34 is paid, the remover of liquidity 32 is charged. The difference in the spread of the make and take is the exchange profit.

The second model is a take/make model. In a take/make model, the taker of liquidity 32 is paid, and the provider of liquidity is charged 34. Again, the difference in the spread of the make and the take is the exchange profit.

The third model is a make/take and take/make model. In a make/take and take/make model, the same principles apply as above for each with the difference being this model operates side by side within the same marketplace. Some trading participants may want this optionality in execution and it is a one size fits all model. Certainly quoting by trading participants will vary by model and arbitrage does exist between models. This would be a first to the futures trading world and not prevalent in any other market known at this time.

The GFS-X 130 leverages established markets that have high volume, actively traded contracts. The creation of these instruments inter-exchange and across continents will naturally create capital efficiency in margining and risk as the “spread alpha” captured is less volatile with a lower VAR than an outright bet.

The GFS-X 130 make/take pricing model is unique to the U.S. futures industry. As an example, the “make/take single pricing model” incentivizes traders to post liquidity into the market. When a trading participant 170 makes 134 or 34 a market and that market is traded 136 and 36, not only does the market maker 134 or 34 receive the desired price, but the exchange cost to trade that GFS-X 130 or 30 is zero. In this same example, when a trading participant 170 takes 132 or 32 liquidity on the GFS-X 130 and 30, either by hitting a posted bid 136 and 36 or lifting a posted offer, they are subject to the standard posted “take” fee. Although “taking” involves a charge—the bid-ask spread plus the take fee—there are many reasons why this still makes sense for a variety of GFS-X trading participants 70, including ease of entry and exit, reduced slippage, arbitrage potential, reduced execution risk and market inefficiencies between products.

An alternative to the make/take trading system is the “take/make single pricing model” as takers of liquidity 132 and 32 are paid while providers 134 and 34 are charged. As expected, many trading participants 70 may be more inclined to transact on this model and true liquidity providers will price the bid-offer differently, but the end result remains the same—if the spread becomes favorable to the bid 32 or offer 34, other trading participants 170 will realize the value of aligning the spread by tightening the bid offer 132 and 32. The underlying price of the futures is what drives the quotes, not the liquidity providers themselves.

The “make/take, take/make dual pricing model” will be a U.S. industry first as both models will trade side-by-side with one another in each contract market so that a trading participant can earmark what market to trade by pricing feature.

A demonstrative example of GFS-X may prove helpful. A money manager may be bullish U.S. interest rates to outperform German interest rates and looks, for example, to the futures market to execute a trade that provides such exposure. Two options exist:

First, the market maker 134 or 34 may go to each individual market such as CME [10 Year Note] and Eurex [10 Year Bund] and execute the trade independently of one another which would involve risks, variation margining on two exchanges and expensive exchange fees.

Alternatively, the trading participant 134 or 34 can “make” a market in the futures exchange option for the 10 year inter-market spread, easily and quickly get market exposure as desired coupled with margin efficiency, all the while collecting exchange fees rather than paying. The futures exchange option for the 10 year market spread is sent to the GFS-X 130 or 30 and converted to U.S. dollars by the conversion device 100 or 200 before it is posted on the GFS-X 130 or 30. The option is published in the exchange GFS-X 30 or 130 for a market taker 132 and 32 to bid or purchase.

The GFS-X 30 target audience is comprised of trading participants including, but not limited to, hedge funds, banks, algorithmic trading companies, institutions as well as the brokerage community—Broker Dealers (BDs) and Futures Commission Merchants (FCMs) and their retail customers. The first three listed trading participants are considered the most knowledgeable and actively trade the outright futures contracts aggressively on a daily basis. They will be the ones that will quickly recognize the benefits of leverage, cost and capital efficiency GFS-X offers.

Another demonstrative example of the trading using GFS-X 30 is set forth below:

All instruments are quoted in dollars and by the dollar spread difference between each. For instance; Eurex 10 year Bund−CME 10 year Note futures instrument. By way of example, if the Eurex 10 year Bund price is bid 123.68 and the offer is 123.69, the bid valuation of 123,680 Euros is converted at the current FX rate to dollars—$172,515. The offer valuation of 123,690 Euros converted at current FX rate to dollars equals $172,529. Additionally, suppose the CME 10 year Note price bid is 121.085 and the offer is 121.090, the bid valuation−dollar value bid of $121,000+(8.5*$31.25) or $265.625 for a dollar bid value of −$121,265.625. The offer valuation−dollar value offer of $121,000+(9*$31.25) or $281.25 for a dollar offer value of $121,281.25.

To “make” liquidity and receive the rebate a trading participant would be on the bid side of one product and the offer side of another, for instance;

### Bid Side:

Bid the Eurex 10 year Bund at $172,515
Offer the CME 10 year Note at $121,281.25
The dollar value of buying German and selling U.S. 10 year rate spread would then equal $172,515−$121,281.25=
   $51,233.75 per instrument

### Offer Side:

Inversely, the same trading participant could also “make” liquidity by offering the same instrument, for instance;
Offer the Eurex 10 year Bund at $172,529
Bid the CME 10 year note at $121,265.625
The dollar value of selling German and buying U.S. 10 year rate spread would then equal $172,529−121,265.625=
   $51,263.375 per instrument

The end result of the example is for the German/U.S. 10 year futures rate spread to a liquidity provider would be a $51,233.75 bid and a $51,263.375 offer. These bids and offers will change dynamically as the underlying products change price and as the Euro FX component moves up and down, a core pricing feature to the GFS-X 30. Liquidity providers (market-makers) 142 and 34 use high speed technology to keep the spreads as tight as possible and liquidity takers 140 and 32 will use those tight spreads to reduce the dollar exposure of independent execution slippage. Accordingly, liquidity providers can and will become “takers” when the arbitrage amongst products turns profitable despite paying the take fee. Product pricing can also be normalized for easy quoting, i.e. the above example could be a rounded 1/10 size or 5124-5126. Rounding also offers the opportunity, for competitive reasons and if business conditions warrant, to pay for “taking liquidity” rather than “making liquidity” as the rounding feature has imbedded “trader edge”. For simplicity, however, all examples used here discuss standard “make (rebate)—take (pay)” fee structures.

The invention operates utilizing cash settled single currency, i.e. U.S. dollar, value delivery system whereby the market maker delivers the single currency value of the instrument on Last Trading Day while the market maker receives the value. In the case of a spread basis going negative to original value, the total of the positive and negative cash amounts will be tendered for delivery. All positions will be marked to the closing prices of the underlying core instruments at a yet to be determined time. FX values will also be marked at that time to take into consideration all dollar related events. Position limits should have the capability to be very large as the true underlying instrument is the single currency.

While the invention has been described with reference to the preferred embodiments thereof, it will be appreciated that numerous variations, modifications, and alternate embodiments are possible, and accordingly, all such variations, modifications, and alternate embodiments are to be regarded as being within the spirit and scope of the invention.

It should be understood that various changes and modifications to the preferred embodiments described would be apparent to those skilled in the art. Changes and modifications can be made without departing from the spirit and scope of the present invention and without diminishing its intended advantages.

What is claimed is:

1. A system for operating a futures spread exchange comprising:
a monitor that tracks an event from a first open exchange and a second open exchange wherein said first and second open exchanges that trade using different monetary currencies;
a conversion device that converts the currency of the events from the first and second open exchanges to a single predetermined currency to generate converted currency data;
an independent exchange that uses the converted currency data to generate a single currency spread product based upon the event from the first open exchange and second open exchange utilizing the exchange converted currency data;
said independent exchange apparatus accepts a bid and offer information pertaining to the single currency spread product; and
a processor within said independent exchange that coordinates a trade based upon said bid and offer information.

2. The system of claim 1, wherein the single currency spread product is a futures spread option.

3. The system of claim 2, wherein the single currency spread product is established upon one open exchange that trades based in treasury notes and another exchange that trades in monetary values.

4. The system of claim 1, wherein the conversion device converts said currency to said U.S. dollars as the single predetermined currency.

5. The system of claim 4, wherein the events from the two open exchanges are based upon the U.S. Treasury Note and the German Bund.

6. The system of claim 1, wherein said event tracked by said monitor is one of said group comprising a quote, an order or a trade.

7. The system of claim 6, wherein the single currency spread product is published to customers.

8. The system of claim 1 further comprising a second conversion device that converts the currency in the independent exchange to a different currency.

9. The system of claim 8, wherein the single currency spread product is published to a customer.

10. The system of 9, wherein the customer provides bid or offer information to said independent exchange.

11. The system of claim 10, wherein the coordinated trade is sent to a clearinghouse.

12. The system of claim 11, wherein the trade is settled in a single currency.

13. The system of claim 9, wherein the single currency spread product is a futures trading product.

14. The system of claim 9, wherein the single currency spread product is an options trading product.

15. The system of claim 9, wherein the single currency spread product is a combination of futures and options.

16. A method for operating a futures exchange based upon futures options spreads from information on various exchanges comprising:
receiving event information from an exchange;
converting the event information to a single currency event information;
generating a single currency spread product based upon the single currency event information;
accepting bid and offer information from a member; and
coordinating a trade between said members based upon said bid and offer information.

17. The method of claim 16 comprising the additional step of converting the monetary value of the coordinated trade to a currency requested by a customer.

18. The method of claim 17 comprising the additional step of sending the converted monetary value of coordinated trade to the customer.

19. The method of claim 18 comprising the additional step of sending said coordinated trade to a clearinghouse.

20. A method for trading a spread based futures instrument comprising:
inputting information based on a first exchange spread that trades using a first currency;
inputting information based on a second exchange spread that trades using a second currency;
determining a currency value factor based upon a predetermined monetary currency;
converting said first exchange spread to a converted first exchange value based on said currency value factor;
converting said second exchange spread to a converted second exchange value based on said currency value factor;
generating a single currency spread product from said first exchange value and second exchange value wherein said single currency spread product is based in said currency value factor;
publishing information regarding said single currency spread product;
receiving offer information regarding said single currency spread product based in said currency value factor;
publishing said offer information;
receiving bid information regarding one of said published offer information or said single currency spread product information;
coordinating a trade based on said received bid information and one of said offer information or said single currency spread product information.

21. The method of claim 20 wherein the currency value factor is in U.S. dollars.

22. The method of claim 20 wherein the single currency spread product is a futures trading product.

23. The method of claim 20 wherein the single currency spread product is an options trading product.

24. The method of claim 20 wherein the single currency spread product is a combination of futures and options trading products.

25. The method of claim 20 comprising the additional step of converting said trade to a predetermined monetary currency and sending said converted trade to a clearinghouse.

26. The method of claim 25 wherein the single currency spread product is a futures trading product.

27. The method of claim 25 wherein the single currency spread product is an options trading product.

28. The method of claim 25 wherein the single currency spread product is a combination of futures and options trading products.
